(19) United States
(12) Patent Application Publication
(10) Pub. No.: US 2026/0019573 A1
(43) Pub. Date: Jan. 15, 2026

(54) Method and Apparatus of ALF with Model-Based Taps in Video Coding System

(71) Applicant: MEDIATEK INC., Hsinchu City (TW)

(72) Inventors: Yu-Ling HSIAO, Hsinchu City (TW); Shih-Chun CHIU, Hsinchu City (TW); Yu-Cheng LIN, Hsinchu City (TW); Chih-Wei HSU, Hsinchu City (TW); Ching-Yeh CHEN, Hsinchu City (TW); Tzu-Der CHUANG, Hsinchu City (TW); Yi-Wen CHEN, San Jose, CA (US); Yu-Wen HUANG, Hsinchu City (TW)

(21) Appl. No.: 19/145,036

(22) PCT Filed: Dec. 27, 2023
(86) PCT No.: PCT/CN2023/142202

§ 371 Date: Jul. 1, 2025

Related U.S. Application Data
(60) Provisional application No. 63/478,705, filed on Jan. 6, 2023.
(60) Provisional application No. 63/439,226, filed on Jan. 16, 2023.

(51) Int. Cl. H04N 19/117; H04N 19/176; H04N 19/186; H04N 19/82

(52) U.S. Cl. CPC H04N 19/117; H04N 19/176; H04N 19/186; H04N 19/82

(57) ABSTRACT

Method and apparatus to generate cross-component model-based taps for ALF. According to this method, input data associated with a current block including a first-colour block and a second-colour block are received, where the first-colour block includes first-colour samples and the second-colour block includes second-colour samples. One or more target second-colour samples are derived according to a Cross-Component Model (CCM) applied to one or more CCM-input first-colour samples or deriving said one or more target second-colour samples at one or more non-integer positions by applying one or more interpolation filters to one or more interpolation-input first-colour or second-colour samples. One or more filtered second-colour samples are generated by applying target ALF (Adaptive Loop Filter) using filter input samples comprising one or more filter-input second-colour samples and said one or more target second-colour samples.

### CROSS REFERENCE TO RELATED APPLICATIONS

The present invention is a non-Provisional application of and claims priority to U.S. Provisional Patent Application No. 63/478,705, filed on Jan. 6, 2023 and U.S. Provisional Patent Application No. 63/439,226, filed on Jan. 16, 2023. The U.S. Provisional Patent Applications are hereby incorporated by reference in their entireties.

### FIELD OF THE INVENTION

The present invention relates to video coding system. In particular, the present invention relates to new techniques to generate model-based tap inputs for ALF (Adaptive Loop Filter).

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously encoded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

### Adaptive Loop Filter in VVC

In VVC, an Adaptive Loop Filter (ALF) with block-based filter adaption is applied. For the luma component, one filter is selected among 25 filters for each 4×4 block, based on the direction and activity of local gradients.

### Filter Shape

Two diamond filter shapes (as shown in FIG. 2) are used. The 7×7 diamond shape 220 is applied for luma component and the 5×5 diamond shape 210 is applied for chroma components.

### Block Classification

For luma component, each 4×4 block is categorized into one out of 25 classes. The classification index C is derived based on its directionality D and a quantized value of activity Â, as follows:

$$C = 5 D + \hat{A} .$$

To calculate D and Â, gradients of the horizontal, vertical and two diagonal direction are first calculated using 1-D Laplacian:

$${g}_{v} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert ,$$

$${g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert ,$$

$${g}_{d 1} = {\sum }_{k = i - 2}^{i + 3} {\sum }_{l = j - 3}^{j + 3} D {1}_{k , l} , D {1}_{k , l} = \vert 2 R ( k , l ) - R ( k - 1 , l - 1 ) - R ( k + 1 , l + 1 ) \vert ,$$

$${g}_{d 2} = {\sum }_{k = i - 2}^{i + 3} {\sum }_{j = j - 2}^{j + 3} D {2}_{k , l} , D {2}_{k , l} = \vert 2 R ( k , l ) - R ( k - 1 , l + 1 ) - R ( k + 1 , l - 1 ) \vert ,$$

where indices i and j refer to the coordinates of the upper left sample within the 4×4 block and R(i, j) indicates a reconstructed sample at coordinate (i, j).

To reduce the complexity of block classification, the subsampled 1-D Laplacian calculation is applied to the vertical direction (FIG. 3A) and the horizontal direction (FIG. 3B). As shown in FIGS. 3C-D, the same subsampled positions are used for gradient calculation of all directions (g_{d1} in FIG. 3C and g_{d2} in FIG. 3D).

Then D maximum and minimum values of the gradients of horizontal and vertical directions are set as:

$${g}_{h , v}^{max} = max ( {g}_{h} , {g}_{v} ) , \qquad {g}_{h , v}^{min} = min ( {g}_{h} , {g}_{v} ) .$$

The maximum and minimum values of the gradient of two diagonal directions are set as:

$${g}_{d 0 , d 1}^{max} = max ( {g}_{d 0} , {g}_{d 1} ) , \qquad {g}_{d 0 , d 1}^{min} = min ( {g}_{d 0} , {g}_{d 1} ) .$$

To derive the value of the directionality D, these values are compared against each other and with two thresholds t₁ and t₂:
Step 1. If both

$${g}_{h , v}^{max} \leq {t}_{1} \cdot {g}_{h , v}^{min} and {g}_{d 0 , d 1}^{max} \leq {t}_{1} \cdot {g}_{d 0 , d 1}^{min}$$

are true, D is set to 0.
Step 2. If

$${g}_{h , v}^{max} / {g}_{h , v}^{min} > {g}_{d 0 , d 1}^{max} / {g}_{d 0 , d 1}^{min} ,$$

continue from Step 3; otherwise continue from Step 4.
Step 3. If

$${g}_{h , v}^{max} > {t}_{2} \cdot {g}_{h , v}^{min} ,$$

D is set to 2; otherwise D is set to 1.
Step 4. If

$${g}_{d 0 , d 1}^{max} > {t}_{2} \cdot {g}_{d 0 , d 1}^{min} ,$$

D is set to 4; otherwise D is set to 3.

The activity value A is calculated as:

$$A = {\sum }_{k = i - 2}^{i + 3} {\sum }_{l = j - 2}^{j + 3} ( {V}_{k , l} + {H}_{k , l} ) .$$

A is further quantized to the range of 0 to 4, inclusively, and the quantized value is denoted as Â.

For chroma components in a picture, no classification is applied.

Geometric transformations of filter coefficients and clipping values

Before filtering each 4×4 luma block, geometric transformations such as rotation or diagonal and vertical flipping are applied to the filter coefficients f(k, l) and to the corresponding filter clipping values c(k, l) depending on gradient values calculated for that block. This is equivalent to applying these transformations to the samples in the filter support region. The idea is to make different blocks to which ALF is applied more similar by aligning their directionality.

Three geometric transformations, including diagonal, vertical flip and rotation are introduced:

$$Diagonal : {f}_{D} ( k , l ) = f ( l , k ) , {c}_{D} ( k , l ) = c ( l , k ) ,$$

$$Vertical flip : {f}_{V} ( k , l ) = f ( k , K - l - 1 ) , {c}_{V} ( k , l ) = c ( k , K - l - 1 ) ,$$

$$Rotation : {f}_{R} ( k , l ) = f ( K - l - 1 , k ) , {c}_{R} ( k , l ) = c ( K - l - 1 , k ) ,$$

where K is the size of the filter and 0≤k, l≤K−1 are coefficients coordinates, such that location (0,0) is at the upper left corner and location (K−1, K−1) is at the lower right corner. The transformations are applied to the filter coefficients f (k, l) and to the clipping values c(k, l) depending on gradient values calculated for that block. The relationship between the transformation and the four gradients of the four directions are summarized in the following table.

TABLE 1
Mapping of the gradient calculated for
one block and the transformations

| Gradient values | Transformation | Transpose indexes |
|---|---|---|
| g_{d2} < g_{d1} and gₕ < gᵥ | No transformation | 0 |
| g_{d2} < g_{d1} and gᵥ < gₕ | Diagonal | 1 |
| g_{d1} < g_{d2} and gₕ < gᵥ | Vertical flip | 2 |
| g_{d1} < g_{d2} and gᵥ < gₕ | Rotation | 3 |

### Filtering Process

At decoder side, when ALF is enabled for a CTB, each sample R(i, j) within the CU is filtered, resulting in sample value R′(i, j) as shown below,

$${R}^{′} ( i , j ) = R ( i , j ) + ( ( {\sum }_{k \neq 0} {\sum }_{l \neq 0} f ( k , l ) \times K ( R ( i + k , j + l ) - R ( i , j ) , c ( k , l ) ) + 64 ) ≫ 7. )$$

where f(k, l) denotes the decoded filter coefficients, K(x, y) is the clipping function and c(k, l) denotes the decoded clipping parameters. The variable k and 1 varies between −L/2 and L/2, where L denotes the filter length. The clipping function K(x, y)=min(y, max(−y, x)) which corresponds to the function Clip3 (−y, y, x). The clipping operation introduces non-linearity to make ALF more efficient by reducing the impact of neighbour sample values that are too different with the current sample value.

### Cross Component Adaptive Loop Filter (CC-ALF)

CC-ALF (or CCALF) uses luma sample values to refine each chroma component by applying an adaptive, linear filter to the luma channel and then using the output of this filtering operation for chroma refinement. FIG. 4A provides a system level diagram of the CC-ALF process with respect to the SAO, luma ALF and chroma ALF processes. As shown in FIG. 4A, each colour component (i.e., Y, Cb and Cr) is processed by its respective SAO (i.e., SAO Luma 410, SAO Cb 412 and SAO Cr 414). After SAO, ALF Luma 420 is applied to the SAO-processed luma and ALF Chroma 430 is applied to SAO-processed Cb and Cr. However, there is a cross-component term from luma to a chroma component (i.e., CC-ALF Cb 422 and CC-ALF Cr 424). The outputs from the cross-component ALF are added (using adders 432 and 434 respectively) to the outputs from ALF Chroma 430.

Filtering in CC-ALF is accomplished by applying a linear, diamond shaped filter (e.g. filters 440 and 442 in FIG. 4B) to the luma channel. In FIG. 4B, a blank circle indicates a luma sample and a dot-filled circle indicate a chroma sample. One filter is used for each chroma channel, and the operation is expressed as:

$$Δ {I}_{i} ( x , y ) = {\sum }_{( {x}_{0} , {y}_{0} ) ∈ {S}_{i}} {I}_{0} ( {x}_{Y} + {x}_{0} , {y}_{Y} + {y}_{0} ) {c}_{i} ( {x}_{0} , {y}_{0} )$$

where (x, y) is chroma component i location being refined, (x_{Y}, y_{Y}) is the luma location based on (x, y), Sᵢ is filter support area in luma component, and cᵢ(x₀, y₀) represents the filter coefficients.

As shown in FIG. 4B, the luma filter support is the region collocated with the current chroma sample after accounting for the spatial scaling factor between the luma and chroma planes.

In the VVC reference software, CC-ALF filter coefficients are computed by minimizing the mean square error of each chroma channel with respect to the original chroma content. To achieve this, the VTM (VVC Test Model) algorithm uses a coefficient derivation process similar to the one used for chroma ALF. Specifically, a correlation matrix is derived, and the coefficients are computed using a Cholesky decomposition solver in an attempt to minimize a mean square error metric. In designing the filters, a maximum of 8 CC-ALF filters can be designed and transmitted per picture. The resulting filters are then indicated for each of the two chroma channels on a CTU basis.

Additional characteristics of CC-ALF include:
The design uses a 3×4 diamond shape with 8 taps.
Seven filter coefficients are transmitted in the APS (Adaptation Parameter Set).
Each of the transmitted coefficients has a 6-bit dynamic range and is restricted to power-of-2 values.
The eighth filter coefficient is derived at the decoder such that the sum of the filter coefficients is equal to 0.
An APS may be referenced in the slice header.
CC-ALF filter selection is controlled at CTU-level for each chroma component
Boundary padding for the horizontal virtual boundaries uses the same memory access pattern as luma ALF.

As an additional feature, the reference encoder can be configured to enable some basic subjective tuning through the configuration file. When enabled, the VTM attenuates the application of CC-ALF in regions that are coded with high QP and are either near mid-grey or contain a large amount of luma high frequencies. Algorithmically, this is accomplished by disabling the application of CC-ALF in CTUs where any of the following conditions are true:
The slice QP value minus 1 is less than or equal to the base QP value.
The number of chroma samples for which the local contrast is greater than (1<<(bitDepth−2))−1 exceeds the CTU height, where the local contrast is the difference between the maximum and minimum luma sample values within the filter support region.
More than a quarter of chroma samples are in the range between

$$( 1 ≪ ( bitDepth - 1 ) ) - 16 and ( 1 ≪ ( bitDepth - 1 ) ) + 16$$

The motivation for this functionality is to provide some assurance that CC-ALF does not amplify artefacts introduced earlier in the decoding path (This is largely due the fact that the VTM currently does not explicitly optimize for chroma subjective quality). It is anticipated that alternative encoder implementations may either not use this functionality or incorporate alternative strategies suitable for their encoding characteristics.

### Filter Parameters Signalling

ALF filter parameters are signalled in Adaptation Parameter Set (APS). In one APS, up to 25 sets of luma filter coefficients and clipping value indexes, and up to eight sets of chroma filter coefficients and clipping value indexes could be signalled. To reduce bits overhead, filter coefficients of different classification for luma component can be merged. In slice header, the indices of the APSs used for the current slice are signalled.

Clipping value indexes, which are decoded from the APS, allow determining clipping values using a table of clipping values for both luma and Chroma components. These clipping values are dependent of the internal bitdepth. More precisely, the clipping values are obtained by the following formula:

$$AlfClip = \{ round ( {2}^{B - α * n} ) for n ∈ [ 0 ... N - 1 ] \}$$

with B equal to the internal bitdepth, a is a pre-defined constant value equal to 2.35, and N equal to 4 which is the number of allowed clipping values in VVC. The AlfClip is then rounded to the nearest value with the format of power of 2.

In slice header, up to 7 APS indices can be signalled to specify the luma filter sets that are used for the current slice. The filtering process can be further controlled at CTB level. A flag is always signalled to indicate whether ALF is applied to a luma CTB. A luma CTB can choose a filter set among 16 fixed filter sets and the filter sets from APSs. A filter set index is signalled for a luma CTB to indicate which filter set is applied. The 16 fixed filter sets are pre-defined and hard-coded in both the encoder and the decoder.

For the chroma component, an APS index is signalled in slice header to indicate the chroma filter sets being used for the current slice. At CTB level, a filter index is signalled for each chroma CTB if there is more than one chroma filter set in the APS.

The filter coefficients are quantized with norm equal to 128. In order to restrict the multiplication complexity, a bitstream conformance is applied so that the coefficient value of the non-central position shall be in the range of −27 to 27-1, inclusive. The central position coefficient is not signalled in the bitstream and is considered as equal to 128.

### Adaptive Loop Filter in ECM

During the recent video standard development, more advanced ALF than the ALF in VVC has been disclosed. The status of the developed coding algorithm is described in ECM (Enhanced Compression Model) and updated during each meeting (e.g. ECM-6, Muhammed Coban, et. al., “Algorithm description of Enhanced Compression Model 6 (ECM 6)”, 27th Meeting, by teleconference, 13-22 Jul. 2022, Document: JVET-AA2025). The ALF filtering process according to ECM is described as follows.

### ALF Simplification

ALF gradient subsampling and ALF virtual boundary processing are removed.

Block size for classification is reduced from 4×4 to 2×2. Filter size for both luma and chroma, for which ALF coefficients are signalled, is increased to 9×9.

ALF with Fixed Filters

To filter a luma sample, three different classifiers (C0, C1 and C2) and three different sets of filters (F0, F1 and F2) are used. Sets F0 and F1 contain fixed filters, with coefficients trained for classifiers C0 and C1. Coefficients of filters in F2 are signalled. Which filter from a set Fi is used for a given sample is decided by a class Cᵢ assigned to this sample using classifier Ci.

### Filtering

At first, two 13×13 diamond shape fixed filters F0 and F1 are applied to derive two intermediate samples R₀(x, y) and R₁(x, y). After that, F2 is applied to R₀(x, y), R₁(x, y), and neighbouring samples to derive a filtered sample as

$$\tilde{R} ( x , y ) = R ( x , y ) + [ {\sum }_{i = 0}^{19} {c}_{i} ( {f}_{i , 0} + {f}_{i , 1} ) ] + [ {\sum }_{i = 20}^{21} {c}_{i} {g}_{i} ] ,$$

where f_{i,j} is the clipped difference between a neighbouring sample and current sample R(x, y) and gᵢ is the clipped difference between Rᵢ₋₂₀(x, y) and current sample. The filter coefficients cᵢ, i=0, . . . 21, are signalled.

### Classification

Based on directionality Dᵢ and activity Âᵢ, a class Cᵢ is assigned to each 2×2 block:

$${C}_{i} = \hat{{A}_{i}} * {M}_{D , i} + {D}_{i} ,$$

where M_{D,i} represents the total number of directionalities Dᵢ.

As in VVC, values of the horizontal, vertical, and two diagonal gradients are calculated for each sample using 1-D Laplacian. The sum of the sample gradients within a 4×4 window that covers the target 2×2 block is used for classifier C0 and the sum of sample gradients within a 12×12 window is used for classifiers C1 and C2. The sums of horizontal, vertical and two diagonal gradients are denoted, respectively, as

$${g}_{h}^{i} , {g}_{v}^{i} , {g}_{d 1}^{i} and {g}_{d 2}^{i} .$$

The directionality Dᵢ is determined by comparing

$${r}_{h , v}^{i} = \frac{max ( {g}_{h}^{i} , {g}_{v}^{i} )}{min ( {g}_{h}^{i} , {g}_{v}^{i} )} , {r}_{d 1 , d 2}^{i} = \frac{max ( {g}_{d 1}^{i} , {g}_{d 2}^{i} )}{min ( {g}_{d 1}^{i} , {g}_{d 2}^{i} )} ,$$

with a set of thresholds. The directionality D₂ is derived as in VVC using thresholds 2 and 4.5. For D₀ and D₁, horizontal/vertical edge strength

$${E}_{HV}^{i}$$

and diagonal edge strength

$${E}_{D}^{i}$$

are calculated first. Thresholds Th=[1.25, 1.5, 2, 3, 4.5, 8] are used. Edge strength

$${E}_{HV}^{i}$$

is 0 if

$${r}_{h , v}^{i} \leq Th [ 0 ] ;$$

otherwise,

$${E}_{HV}^{i}$$

is the maximum integer such that

$${r}_{h , v}^{i} > Th [ {E}_{HV}^{i} - 1 ] .$$

Edge strength

$${E}_{D}^{i}$$

is 0 if

$${r}_{d 1 , d 2}^{i} \leq Th [ 0 ] ;$$

otherwise,

$${E}_{D}^{i}$$

is the maximum integer such that

$${r}_{d 1 , d 2}^{i} > Th [ {E}_{D}^{i} - 1 ] .$$

### When

$${r}_{h , v}^{i} > {r}_{d 1 , d 2}^{i} ,$$

i.e., horizontal/vertical edges are dominant, the Dᵢ is derived by using Table 2A; otherwise, diagonal edges are dominant, the Dᵢ is derived by using Table 2B.

TABLE 2A
$Mapping of {E}_{D}^{i} and {E}_{HV}^{i} to {D}_{i}$

| | ${E}_{D}^{i}$ | | | | | | |
|---|---|---|---|---|---|---|---|
| ${E}_{HV}^{i}$ | 0 | 1 | 2 | 3 | 4 | 5 | 6 |
| 0 | 0 | 0 | 0 | 0 | 0 | 0 | 0 |
| 1 | 1 | 2 | 0 | 0 | 0 | 0 | 0 |
| 2 | 3 | 4 | 5 | 0 | 0 | 0 | 0 |
| 3 | 6 | 7 | 8 | 9 | 0 | 0 | 0 |
| 4 | 10 | 11 | 12 | 13 | 14 | 0 | 0 |
| 5 | 15 | 16 | 17 | 18 | 19 | 20 | 0 |
| 6 | 21 | 22 | 23 | 24 | 25 | 26 | 27 |

TABLE 2B
$Mapping of {E}_{D}^{i} and {E}_{HV}^{i} to {D}_{i}$

| | ${E}_{HV}^{i}$ | | | | | | |
|---|---|---|---|---|---|---|---|
| ${E}_{D}^{i}$ | 0 | 1 | 2 | 3 | 4 | 5 | 6 |
| 0 | 28 | 0 | 0 | 0 | 0 | 0 | 0 |
| 1 | 29 | 30 | 0 | 0 | 0 | 0 | 0 |
| 2 | 31 | 32 | 33 | 0 | 0 | 0 | 0 |
| 3 | 34 | 35 | 36 | 37 | 0 | 0 | 0 |
| 4 | 38 | 39 | 40 | 41 | 42 | 0 | 0 |
| 5 | 43 | 44 | 45 | 46 | 47 | 48 | 0 |
| 6 | 49 | 50 | 51 | 52 | 53 | 54 | 55 |

To obtain Âᵢ, the sum of vertical and horizontal gradients Aᵢ is mapped to the range of 0 to n, where n is equal to 4 for Â₂ and 15 for Â₀ and Â₁.

In an ALF_APS, up to 4 luma filter sets are signalled, each set may have up to 25 filters.

### Convolutional Cross-Component Model (CCCM)

In this method convolutional cross-component model (CCCM) is applied to predict chroma samples from reconstructed luma samples in a similar spirit as done by the current CCLM modes. As with CCLM, the reconstructed luma samples are down-sampled to match the lower resolution chroma grid when chroma sub-sampling is used. Similar to CCLM top, left or top and left reference samples are used as templates for model derivation.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

### Convolutional Filter

The convolutional 7-tap filter consist of a 5-tap plus sign shape spatial component, a nonlinear term and a bias term. The input to the spatial 5-tap component of the filter consists of a centre (C) luma sample which is collocated with the chroma sample to be predicted and its above/north (N), below/south (S), left/west (W) and right/east (E) neighbours as illustrated in FIG. 5.

The nonlinear term (denoted as P) is represented as power of two of the centre luma sample C and scaled to the sample value range of the content:

$$P = ( C * C + midVal ) >> \text{bitDepth.}$$

For example, for 10-bit contents, the nonlinear term is calculated as:

$$P + ( C * C = 512 ) >> 10$$

The bias term (denoted as B) represents a scalar offset between the input and output (similarly to the offset term in CCLM) and is set to the middle chroma value (512 for 10-bit content).

Output of the filter is calculated as a convolution between the filter coefficients ci and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B .$$

### Calculation of Filter Coefficients

The filter coefficients cᵢ are calculated by minimising MSE between predicted and reconstructed chroma samples in the reference area. FIG. 6 illustrates an example of the reference area which consists of 6 lines of chroma samples above and left of the PU. Reference area extends one PU width to the right and one PU height below the PU boundaries. Area is adjusted to include only available samples. The extensions to the area (indicated as “extension area”) are needed to support the “side samples” of the plus-shaped spatial filter in FIG. 5 and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

The autocorrelation matrix is calculated using the reconstructed values of luma and chroma samples. These samples are full range (e.g. between 0 and 1023 for 10-bit content) resulting in relatively large values in the autocorrelation matrix. This requires high bit depth operation during the model parameters calculation. It is proposed to remove fixed offsets from luma and chroma samples in each PU for each model. This is driving down the magnitudes of the values used in the model creation and allows reducing the precision needed for the fixed-point arithmetic. As a result, 16-bit decimal precision is proposed to be used instead of the 22-bit precision of the original CCCM implementation.

Reference sample values just outside of the top-left corner of the PU are used as the offsets (offsetLuma, offsetCb and offsetCr) for simplicity. The sample values used in both model creation and final prediction (i.e., luma and chroma in the reference area, and luma in the current PU) are reduced by these fixed values, as follows:

$$\begin{matrix}{C}^{′} = C - offsetLuma , \\ {N}^{′} = N - offsetLuma , \\ {S}^{′} = S - offsetLuma , \\ {E}^{′} = E - offsetLuma , \\ {W}^{′} = W - offsetLuma , \\ {P}^{′} = nonLinear ( {C}^{′} ) , \\ B = midValue = 1 << ( bitDepth - 1 ) ,\end{matrix}$$

and the chroma value is predicted using the following equation, where offsetChroma is equal to offsetCr and offsetCb for Cr and Cb components, respectively:

$$predChromaVal = c 0 {C}^{′} + c 1 {N}^{′} + c 2 {S}^{′} + c 3 {E}^{′} + c 4 {W}^{′} + c 5 {P}^{′} + c 6 B + offsetChroma .$$

In order to avoid any additional sample level operations, the luma offset is removed during the luma reference sample interpolation. This can be done, for example, by substituting the rounding term used in the luma reference sample interpolation with an updated offset including both the rounding term and the offsetLuma. The chroma offset can be removed by deducting the chroma offset directly from the reference chroma samples. As an alternative way, the impact of the chroma offset can be removed from the cross-component vector giving an identical result. In order to add the chroma offset back to the output of the convolutional prediction operation, the chroma offset is added to the bias term of the convolutional model.

The process of CCCM model parameter calculation requires division operations. Division operations are not always considered implementation friendly. The division operations are replaced with multiplication (with a scaling factor) and shift operation, where the scaling factor and the number of shifts are calculated based on a denominator similar to the method used in calculation of CCLM parameters.

### Gradient Linear Model (GLM)

For YUV 4:2:0 colour format, a gradient linear model (GLM) method can be used to predict the chroma samples from luma sample gradients. Two modes are supported: a two-parameter GLM mode and a three-parameter GLM mode.

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

In the three-parameter GLM, a chroma sample can be predicted based on both the luma sample gradients and down-sampled luma values with different parameters. The model parameters of the three-parameter GLM are derived from 6 rows and columns adjacent samples by the LDL decomposition based MSE minimization method as used in the CCCM.

$$C = {α}_{0} \cdot G + {α}_{1} \cdot L + {α}_{2} \cdot β$$

For signalling, when the CCLM mode is enabled for the current CU, two flags are signalled separately for Cb and Cr components to indicate whether GLM is enabled for each component or one GLM flag is signalled for both Cb and Cr component with a shared GLM index. If the GLM is enabled for one component, one syntax element is further signalled to select one of a plurality of gradient filters (710-740 in FIG. 7) for the gradient calculation. The GLM can be combined with the existing CCLM by signalling one extra flag in bitstream. When such combination is applied, the filter coefficients that are used to derive the input luma samples of the linear model are calculated as the combination of the selected gradient filter of the GLM and the down-sampling filter of the CCLM.

### Bitstream Signalling

Usage of the mode is signalled with a CABAC coded PU level flag. One new CABAC context was included to support this. When it comes to signalling, CCCM is considered a sub-mode of CCLM. That is, the CCCM flag is only signalled if intra prediction mode is LM_CHROMA.

In the present invention, techniques to generate cross-component model-based taps for ALF are disclosed in order to improve performance.

### BRIEF SUMMARY OF THE INVENTION

Method and apparatus to generate cross-component model-based taps for ALF are disclosed. According to this method, input data associated with a current block comprising a first-colour block and a second-colour block are received, wherein the first-colour block comprises first-colour samples and the second-colour block comprises second-colour samples. One or more target second-colour samples are derived according to a Cross-Component Model (CCM) applied to one or more CCM-input first-colour samples or deriving said one or more target second-colour samples at one or more non-integer positions by applying one or more interpolation filters to one or more interpolation-input first-colour or one or more interpolation-input second-colour samples. One or more filtered second-colour samples are generated by applying target ALF (Adaptive Loop Filter) using filter input samples comprising one or more filter-input second-colour samples and said one or more target second-colour samples.

In one embodiment, the Cross-Component Model corresponds to an ALF-type filtering process. In one embodiment, the coefficients associated with the Cross-Component Model are derived using reconstructed first-colour samples and reconstructed second-colour samples of a neighbouring reference area and/or the current block. In one embodiment, the reconstructed first-colour samples and the reconstructed second-colour samples of the neighbouring reference area correspond to reconstructed samples before or after an ALF filtering process. In one embodiment, the neighbouring reference area is classified into multiple areas and one Cross-Component Model is derived for each of the multiple areas. In one embodiment, said one or more target second-colour samples are derived by applying said one Cross-Component Model according to a class associated with one of the multiple areas.

In one embodiment, said one or more CCM-input first-colour samples correspond to reconstructed first-colour samples before or after an ALF filtering process.

In one embodiment, said one or more target second-colour samples are used for the target ALF independently. In one embodiment, the target ALF is separate from a luma ALF, chroma ALF, or Cross-Component ALF (CCALF) filtering process.

In one embodiment, the Cross-Component Model corresponds to a CCCM (Convolutional Cross-Component Model)-type filtering process.

In one embodiment, said one or more target second-colour samples are used as reconstructed samples after applying an ALF filtering process.

In one embodiment, one or more coefficients of the target ALF are signalled or parsed from a video bitstream.

In one embodiment, said one or more interpolation filters correspond to one or more upscaling filters, one or more downscaling filters or both.

In one embodiment, the first-colour samples correspond to luma samples and the second-colour samples correspond to chroma samples, the first-colour samples correspond to the chroma samples and the second-colour samples correspond to the luma samples, or the first-colour samples and the second-colour samples correspond to two different chroma components.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIG. 2 illustrates the ALF filter shapes for the chroma (left) and luma (right) components.

FIGS. 3A-D illustrates the subsampled Laplacian calculations for gᵥ (3A), gₕ (3B), g_{d1} (3C) and g_{d2} (3D).

FIG. 4A illustrates the placement of CC-ALF with respect to other loop filters.

FIG. 4B illustrates a diamond shaped filter for the chroma samples.

FIG. 5 illustrates an example of spatial part of the convolutional filter.

FIG. 6 illustrates an example of reference area with extension areas used to derive the filter coefficients.

FIG. 7 illustrates the 4 gradient patterns for Gradient Linear Model (GLM).

FIG. 8 illustrates examples of unscaled filter footprint (left) and scaled footprint (right) for a scaling factor equal to 2.

FIG. 9 illustrates a flowchart of an exemplary video coding system using a new type of input taps for Adaptive Loop Filtering (ALF) according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In order to further improve the coding performance for systems using ALF, new types of input taps is disclosed as follows.

ALF with Model-Based Taps

In general, ALF reconstruction process can be represented by:

$$\tilde{R} ( x , y ) = R ( x , y ) + [ {\sum }_{i = 0}^{K - 1} {c}_{i} {n}_{i} ] ,$$

where R(x, y) is the sample value before ALF filtering, R(x, y) is the sample value after ALF filtering, cᵢ is the i-th filter coefficient, and nᵢ is the i-th filter tap input. Specifically, nᵢ is a clipped neighbouring difference value, a clipped correction value from another filter, or a clipped correction value from another in-loop filtering stage. In this invention, additional taps are introduced, and the new tap inputs, nᵢ are generated from some model predictions instead of from existing sample values, where the model can be an interpolation process, an ALF-like filtering process, or a CCCM-like prediction process. The above equation shows a general form of ALF. The ALF-like (or ALF-type) filtering process refers to any ALF filtering process having the filtering process as shown in the above equation. However, the footprints may have any shape and are not limited to the examples in FIG. 2. Furthermore, the number of taps and the types of taps are not limited to those disclosed in various versions of ECM. On the other hand, the CCCM-like (or CCCM-type) prediction process can be any convolutional filter and are not limited to the example shown in FIG. 5. The CCCM-type prediction process may use more or less input samples than those shown in FIG. 5.
ALF with Taps Generated from Interpolated Samples

In one embodiment, given a scaling factor and a set of interpolation filter coefficients, sample values at non-integer positions in a region are generated for one component (Y, Cb, or Cr), and the sample values in the upscaled/downscaled region are used to derive the ALF tap inputs ni for the same component.
Example 1. The upscaled/downscaled luma is used to derive luma ALF tap inputs.
Example 2. The upscaled/downscaled Cb/Cr is used to derive chroma ALF tap inputs.

In another embodiment, the sample values in the upscaled/downscaled region are used to derive the ALF tap inputs ni for another component.
Example 3. The upscaled/downscaled Cb/Cr is used to derive luma ALF tap inputs.
Example 4. The upscaled/downscaled luma is used to derive chroma ALF or CCALF tap inputs.
Example 5. The upscaled/downscaled Cb/Cr is used to derive chroma ALF tap inputs for the other colour component Cr/Cb.

In the above embodiment, the scaling factor(s) and the coefficients of interpolation filter(s) can be explicitly signalled or implicitly determined. The decision of scaling factors can be related to the chroma subsampling format. For example, if the chroma subsampling format is 420, horizontal and vertical scaling factors are both set to 2 for chroma components. For another example, if the chroma subsampling format is 422, the horizontal scaling factor is set to 2 while the vertical scaling factor is set to 1 for chroma components.

In the above embodiments, either an unscaled filter footprint or a scaled filter footprint is used. For example, if 3×3 diamond shape is used and the scaling factor is set to 2, FIG. 8 shows two different options of the filter footprint, where unsealed filter footprint 810 is shown on the left and scaled footprint 820 is shown on the right.

ALF with Taps Generated from Another ALF Filters

In ECM ALF, fixed filtered results are used to derive the ALF tap inputs ni. However, the fixed filters are offline trained and may not be suitable for the current coding frame sometimes. Therefore, it is proposed that fixed filters can be replaced with or assisted with filters in history APS.

In one embodiment, if history APS is present, fixed filters can be replaced with filters in the history APS. That is, some ALF tap inputs ni are no longer related to fixed filters, and the filters in history APS are used to derive those ALF tap inputs instead. In another embodiment, if history APS is present, additional taps can be introduced into ALF, where the additional tap inputs are derived by using filters in history APS. That is, some ALF tap inputs ni are still related to fixed filters, and the filters in history APS are used to derive additional ALF tap inputs.

ALF with Taps Generated from Cross-Component Models (CCM)

In one embodiment, to utilize the chroma samples from applying cross-component model to luma samples to chroma ALF filtering process with signalled coefficients, the following steps can be applied:
Derive coefficients of luma-to-chroma cross-component model using reconstructed luma and chroma samples of neighbouring reference area and/or the current block.
Derive chroma samples of the current block by applying luma-to-chroma cross-component model to luma samples of the current block.
Chroma filtering process by signalled coefficients with the chroma samples and the chroma samples from cross-component model.

In the above embodiment, the chroma-to-luma cross-component model can also be applied, that is, to utilize the luma samples from applying cross-component model to chroma samples to luma ALF or CCALF filtering process with signalled coefficients, the following steps could be applied:
Derive coefficients of chroma-to-luma cross-component model using reconstructed chroma and luma samples of neighbouring reference area and/or the current block.
Derive luma samples of the current block by applying chroma-to-luma cross-component model to chroma samples of the current block.
ALF luma or CCALF filtering process by signalled coefficients with the luma samples and the luma samples from cross-component model.

In the above embodiment, the reconstructed luma and chroma samples of neighbouring reference area used for deriving coefficients of cross-component model can be samples before applying ALF filtering process or samples after applying ALF filtering process.

In the above embodiment, the reconstructed luma or chroma samples of current block used for deriving samples from cross-component model could be samples before applying ALF filtering process or samples after applying ALF filtering process.

In the above embodiment, the samples from cross-component model can be used independently for filtering process, and separate from chroma ALF, luma ALF, and/or CCALF filtering process.

One example is shown as follows:
Derive coefficients of luma-to-chroma cross-component model using reconstructed luma and chroma samples of neighbouring reference area and/or the current block.
Derive chroma samples of current block by applying luma-to-chroma cross-component model to luma samples of the current block.
Chroma filtering process by signalled coefficients with the chroma samples from the cross-component model.

In the above embodiment, the samples from cross-component model can be used as reconstructed samples after applying ALF filtering process.

In one embodiment, multiple cross-component models can be derived by classifying reference area into multiple areas, and the derive cross-component model for each reference area. Then, apply corresponding cross-component model by class when applying cross-component model to samples of current block:
Classified by ALF APS classification or ALF fixed filter classification
Classified by position

One example is shown as follows:
Classify neighbouring reference area into multiple areas.
Derive coefficients of luma-to-chroma cross-component model by reconstructed luma and chroma samples of neighbouring reference area, and derive cross-component model for each reference area.
Derive chroma samples of the current block by applying luma-to-chroma cross-component model to luma samples of the current block. Then, for each chroma sample, choosing luma-to-chroma cross-component model by the class of chroma sample or the class of corresponding luma sample.
Chroma filtering process by signalled coefficients with the chroma samples and the chroma samples from the cross-component model.

### ALF Constraints for Multiple Sources

In the exploration of ECM, the ALF process utilizes samples in different coding stages, such as residual samples, predictor samples, collocated reference samples, samples before the deblocking filter, samples before ALF, samples filtered by fixed filter sets. In this invention, several constraints are proposed to reduce the buffer usage for such multi-source ALF design.

Assume that there are N sources available for ALF, denoted as S₁, S₂, S₃, . . . , S_{N}. In one embodiment, the source selection is in APS (e.g. at APS level, filter set level, or filter level), and the total number of sources used for all samples in one block, region, slice, tile, subpicture, picture or sequence cannot exceed a number K, where K is an integer less than N.

One example according to this embodiment is shown as follows.
In case that 4 sources are available (N=4) and at most 2 sources are allowed (K=2), if an APS, filter set or filter that selects source S₁ and S₃ has already been selected at the block, region, slice, tile, subpicture, picture or sequence level, other APSs, filter sets or filters that select source S₂ or S₄ are forbidden for the current block, region, slice, tile, subpicture, picture or sequence.

Another example according to this embodiment is shown as follows.
In case that 4 sources are available (N=4) and at most 2 sources are allowed (K=2), if an APS, filter set or filter that selects source S₁ and S₃ has already been selected at the block, region, slice, tile, subpicture, picture or sequence level, other APSs, filter sets or filters that select source S₂ or S₄ are still allowed for the current block, region, slice, tile, subpicture, picture or sequence. However, when applying those APSs, filter sets or filters to samples, a pseudo source will be used instead of the actual source. For example, if an ALF tap input is generated by using residual samples but the residual samples are disallowed (being one of source S₂ or S₄), the tap input will be fed with a zero, a pre-determined constant value, or a value derived by replacing the residual samples with pre-ALF samples or other samples from an allowed source.
In another embodiment, one source selection is at the block, region, slice, tile, subpicture, picture or sequence level, while another source selection is in APS (i.e., at APS level, filter set level, or filter level). For the first source selection at the block, region, slice, tile, subpicture, picture or sequence level, a maximum number of K sources can be selected, where K is an integer less than N.

Another example according to this embodiment is shown as follows.
In case that 4 sources are available (N=4) and at most 2 sources are allowed (K=2), if sources S₁ and S₃ are selected at the block, region, slice, tile, subpicture, picture or sequence level, APSs, filter sets and filters that select source S₂ or S₄ are forbidden for the block, region, slice, tile, subpicture, picture or sequence.

Another example according to this embodiment is shown as follows.
In case that 4 sources are available (N=4) and at most 2 sources are allowed (K=2), if sources S₁ and S₃ are selected at the block, region, slice, tile, subpicture, picture or sequence level, APSs, filter sets or filters that select source S₂ or S₄ are still allowed for the current block, region, slice, tile, subpicture, picture or sequence. However, when applying those APSs, filter sets or filters to samples, a pseudo source will be used instead of the actual source.
In another embodiment, the source selection is at the block, region, slice, tile, subpicture, picture or sequence level, and there is no source selection in APS (i.e., at APS level, filter set level, or filter level). For the source selection, a maximum number of K sources can be selected, where K is an integer less than N.

Another example according to this embodiment is shown as follows.
In case that 4 sources are available (N=4) and at most 2 sources are allowed (K=2), at most 2 sources are selected at the block, region, slice, tile, subpicture, picture or sequence level and used to indicate how to use the information signalled in APS. Specifically, for a current slice, if the source “pre-ALF samples” and “residual samples” are selected, the filter coefficients signalled in a selected APS will be multiplied by some values derived from “pre-ALF samples” and “residual samples” for filtering the samples in the current slice; while for another slice, if the source “pre-ALF samples” and “collocated reference samples” are selected and the same APS is used, the same filter coefficients will be multiplied by some value derived from the “pre-ALF samples” and “collocated reference samples” for filtering the samples.

The foregoing proposed methods can be implemented in encoders and/or decoders. For example, the proposed method can be implemented in an in-loop filtering module of an encoder, and/or an in-loop filtering module of a decoder.

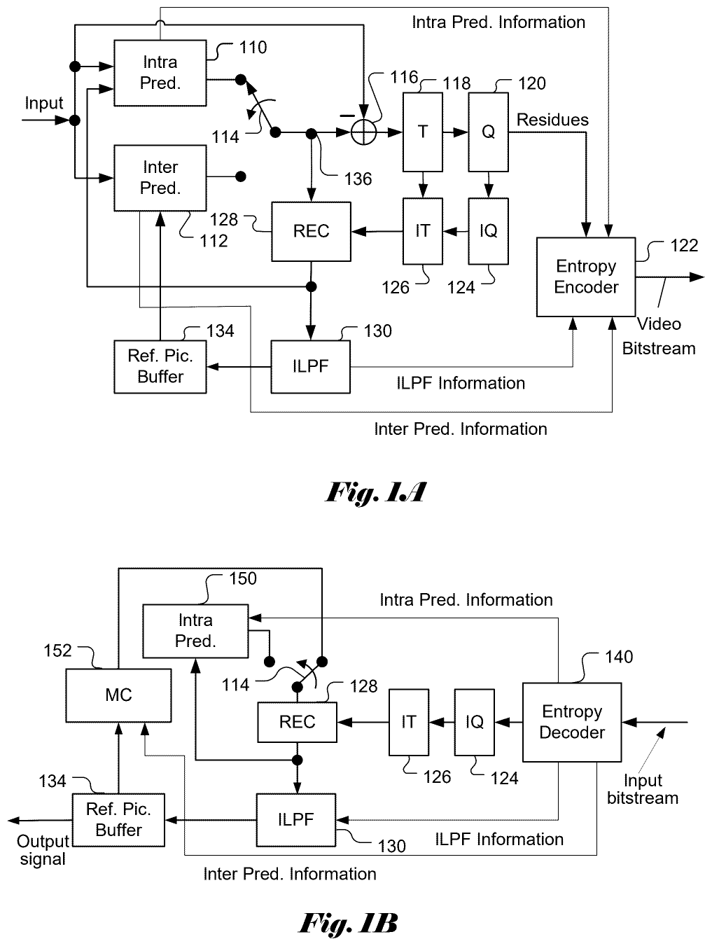

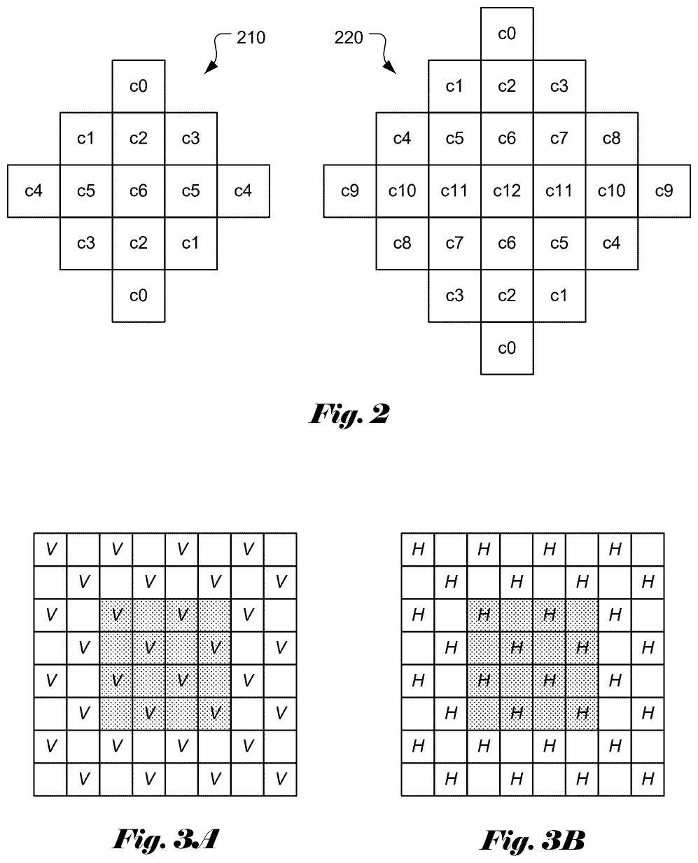

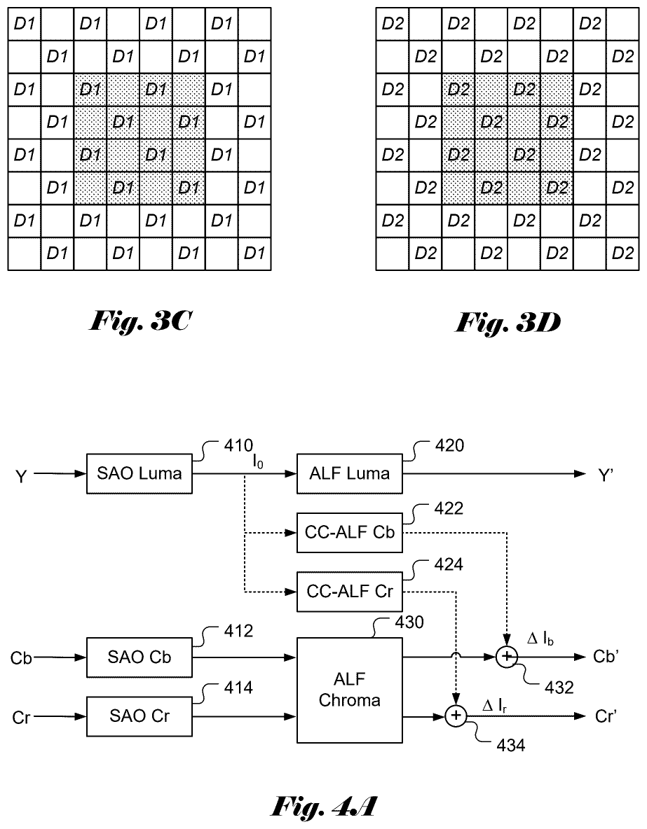

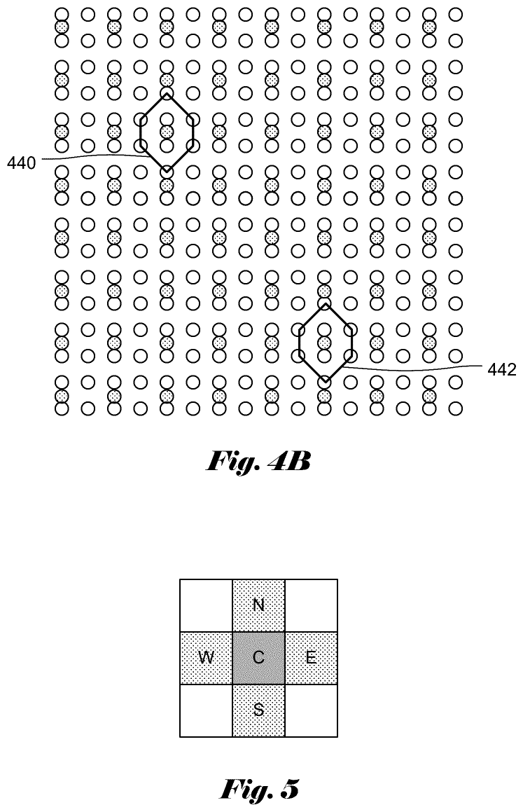

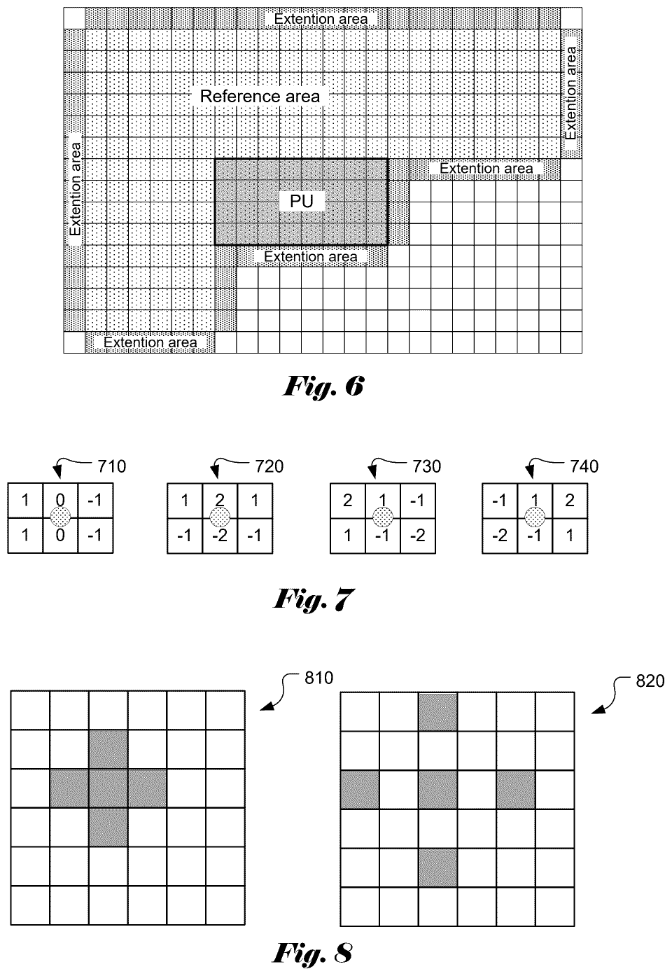

The ALF filtering process with new types of input taps as described above can be implemented in an encoder side or a decoder side. For example, any of the proposed methods can be implemented in an Inter and/or Intra prediction modules (e.g. In-Loop Filter (ILPF) 130 in FIG. 1A and FIG. 1B) in an encoder or decoder. Any of the proposed methods can also be implemented as a circuit coupled to the inter/intra coding module at the decoder or the encoder. However, the decoder or encoder may also use additional processing unit to implement the required processing. While the In-Loop Filter units (e.g. unit 130 in FIG. 1A and FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

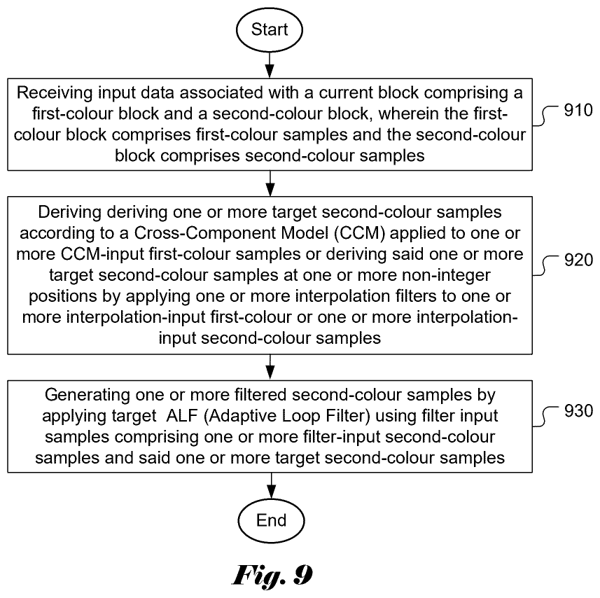

FIG. 9 illustrates a flowchart of an exemplary video coding system using a new type of input taps for Adaptive Loop Filtering (ALF) according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current block comprising a first-colour block and a second-colour block are received in step 910, wherein the first-colour block comprises first-colour samples and the second-colour block comprises second-colour samples. One or more target second-colour samples are derived according to a Cross-Component Model (CCM) applied to one or more CCM-input first-colour samples or deriving said one or more target second-colour samples at one or more non-integer positions by applying one or more interpolation filters to one or more interpolation-input first-colour or one or more interpolation-input second-colour samples in step 920. One or more filtered second-colour samples are generated by applying target ALF (Adaptive Loop Filter) using filter input samples comprising one or more filter-input second-colour samples and said one or more target second-colour samples in step 930.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of processing colour pictures, the method comprising:
receiving input data associated with a current block comprising a first-colour block and a second-colour block, wherein the first-colour block comprises first-colour samples and the second-colour block comprises second-colour samples;
deriving one or more target second-colour samples according to a Cross-Component Model (CCM) applied to one or more CCM-input first-colour samples or deriving said one or more target second-colour samples at one or more non-integer positions by applying one or more interpolation filters to one or more interpolation-input first-colour or one or more interpolation-input second-colour samples; and
generating one or more filtered second-colour samples by applying target ALF (Adaptive Loop Filter) using filter input samples comprising one or more filter-input second-colour samples and said one or more target second-colour samples.

2. The method of claim 1, wherein the Cross-Component Model corresponds to an ALF-type filtering process.

3. The method of claim 2, wherein coefficients associated with the Cross-Component Model are derived using reconstructed first-colour samples and reconstructed second-colour samples of a neighbouring reference area and/or the current block.

4. The method of claim 3, wherein the reconstructed first-colour samples and the reconstructed second-colour samples of the neighbouring reference area correspond to reconstructed samples before or after an ALF filtering process.

5. The method of claim 3, wherein the neighbouring reference area is classified into multiple areas and one Cross-Component Model is derived for each of the multiple areas.

6. The method of claim 5, wherein said one or more target second-colour samples are derived by applying said one Cross-Component Model according to a class associated with one of the multiple areas.

7. The method of claim 2, wherein said one or more CCM-input first-colour samples correspond to reconstructed first-colour samples before or after an ALF filtering process.

8. The method of claim 1, wherein said one or more target second-colour samples are used for the target ALF independently.

9. The method of claim 8, wherein the target ALF is separate from a luma ALF, chroma ALF, or Cross-Component ALF (CCALF) filtering process.

10. The method of claim 1, wherein the Cross-Component Model corresponds to a CCCM (Convolutional Cross-Component Model)-type filtering process.

11. The method of claim 1, wherein said one or more target second-colour samples are used as reconstructed samples after applying an ALF filtering process.

12. The method of claim 1, wherein one or more coefficients of the target ALF are signalled or parsed from a video bitstream.

13. The method of claim 1, wherein said one or more interpolation filters correspond to one or more upscaling filters, one or more downscaling filters or both.

14. The method of claim 1, wherein the first-colour samples correspond to luma samples and the second-colour samples correspond to chroma samples, the first-colour samples correspond to the chroma samples and the second-colour samples correspond to the luma samples, or the first-colour samples and the second-colour samples correspond to two different chroma components.

15. An apparatus for processing of coded video, the apparatus comprising one or more electronics or processors arranged to:
receive input data associated with a current block comprising a first-colour block and a second-colour block, wherein the first-colour block comprises first-colour samples and the second-colour block comprises second-colour samples;
derive one or more target second-colour samples according to a Cross-Component Model (CCM) applied to one or more CCM-input first-colour samples or deriving said one or more target second-colour samples at one or more non-integer positions by applying one or more interpolation filters to one or more interpolation-input first-colour or one or more interpolation-input second-colour samples; and
generate one or more filtered second-colour samples by applying target ALF (Adaptive Loop Filter) using filter input samples comprising one or more filter-input second-colour samples and said one or more target second-colour samples.
